(19) United States
(12) Patent Application Publication
(10) Pub. No.: US 2014/0055387 A1
(43) Pub. Date: Feb. 27, 2014

(54) PORTABLE ELECTRONIC DEVICE AND AUTOMATIC UNLOCKING METHOD THEREOF

(71) Applicant: WISTRON CORP., NEW TAIPEI CITY (TW)

(72) Inventor: YU-PING YEH, NEW TAIPEI CITY (TW)

(73) Assignee: WISTRON CORP., NEW TAIPEI CITY (TW)

(21) Appl. No.: 13/844,883

(22) Filed: Mar. 16, 2013

(30) Foreign Application Priority Data
Aug. 24, 2012 (TW) 101130792

(51) Int. Cl. G06F 3/0488

(52) U.S. Cl. CPC G06F 3/0488
USPC 345/173; 345/156

(57) ABSTRACT

A portable electronic device having a suspend mode and a work mode is illustrated. The portable electronic device includes a body, a touch sense module and an identifying module. The body includes a casing. The touch sense module has a plurality of touch sensors disposed on the surface of the casing and used for sensing a contact gesture of a user. The identifying module is placed in the body and used for retrieving an identification data. When the portable electronic device is switched to the suspend mode, the touch sense module is enabled to sense the contact gesture. When the contact gesture matches a predetermined gesture, the identifying module is enabled to retrieve the identification data wirelessly. The portable electronic device is switched from the suspend mode to the work mode when is the identification data is confirmed.

### BACKGROUND OF THE INVENTION

1. Field of the Invention

The instant disclosure relates to a portable electronic device and a method thereof; in particular, it relates to a portable electronic device and an automatic unlocking method thereof.

2. Description of Related Art

In recent years, due to a continuous development of improving techniques of a portable electronic device such as a tablet PC, a smart phone, or a multimedia player, dependence of the user for such electronic device is growing, and the portable electronic device is constantly used for storage of frequently used personal information or messages. For long-time usage and protection of personal information for the user, in most cases, the portable electronic device is set to shut the screen and being switched to a stand-by mode to save power after being idle for a certain time period, and start protection to prevent people without permissions from obtaining information in the portable electronic device.

When the user intends to use the portable electronic device again, it is needed to switch the screen on and to enter a code or an unlocking pattern manually to unlock the protection. However, several seconds taken by unlocking the protection manually are easily considered inconvenient for the users, and process of unlocking is possibly peeked by others and then another issue of leaking unlocking information is generated. Yet, if the protection is canceled for better convenience, the information stored in the portable electronic device is easily stolen for incomplete protection.

Therefore, to give consideration to both the security of the information in the portable electronic device and the convenience for the user, it is worth to look into the problem and make improvements.

### SUMMARY OF THE INVENTION

In an embodiment of the instant disclosure provides a portable electronic device having a suspend mode and a work mode, and the portable electronic device includes a body, a touch-control sensing module and an identifying module. The body has a casing. The touch-control sensing module has a plurality of touch-control sensors, and the touch-control sensors are disposed on the casing for sensing a contact gesture of a user. The identifying module is placed in the body for retrieving an identification data. When the portable electronic device is switched to the suspend mode, the touch-control sensing module is enabled to sense the contact gesture of the user, and when the contact gesture sensed by the touch-control sensing module matches a predetermined gesture, the identifying module is enabled to retrieve the identification data wirelessly. After the identification data is confirmed by the identifying module, the portable electronic device is switched from the suspend mode to the work mode.

In an embodiment of the instant disclosure provides an alternative portable electronic device having a suspend mode and a work mode, and the portable electronic device includes a body, a motion sensing module and an identifying module. The body has a casing. The motion sensing module is for sensing a motion status of the portable electronic device. The identifying module is placed in the body for retrieving an identification data. When the portable electronic device is under the suspend mode, and the motion sensing module is enabled to sense the motion status of the portable electronic device, and when the motion sensing module senses that the motion status of the portable electronic device matches a predetermined status, the identifying module is enabled to retrieve an identification data wirelessly. After the identification data is confirmed by the identifying module, the portable electronic device is switched from the suspend mode to the work mode.

Moreover, in an embodiment of the instant disclosure provides an automatic unlocking method of a portable electronic device. The portable electronic device has a touch-control sensing module and an identifying module, and the touch-control sensing module has a plurality of touch-control sensors, and the portable electronic device has a suspend mode and a work mode, and the method includes: disposing the plurality of touch-control sensors on a casing of the portable electronic device; sensing a contact gesture of a user with the touch-control sensors when the portable electronic device is switched to the suspend mode; determining whether a contact gesture matches a predetermined gesture; enabling the identifying module to retrieve an identification data wirelessly when the contact gesture matches the predetermined gesture; and the portable electronic device being switched from the suspend mode to the work mode when the identification data is confirmed by the identifying module.

In an embodiment of the instant disclosure provides an alternative automatic unlocking method of a portable electronic device. The portable electronic device includes a motion sensing module and an identifying module, and has a suspend mode and a work mode, and the method includes: sensing a motion status of the portable electronic device with the motion sensing module when the portable electronic device is switched to the suspend mode; determining whether the motion status matches a predetermined status; enabling the identifying module to retrieve an identification data when the motion status matches the predetermined status; and the portable electronic device being switched from the suspend mode to the work mode when the identification data is confirmed by the identifying module.

Based on the above, the portable electronic devices and the unlocking methods thereof provided by the embodiments of the instant disclosure are executable when the portable electronic device is switched to the suspend mode, and specific contact gesture of the user and specific motion status of the portable electronic device sensed by the sensing modules determine whether to arouse the portable electronic device, and to retrieve the identification data automatically to switch the portable electronic device back to the work mode accordingly. Thereby, it is assured that only the users with a confirmed identification data unlock the protection of the electronic devices and use the portable electronic devices, and with the identification data of the portable electronic device being automatically retrieved, the convenience for the user is improved for no need of entering unlocking information manually, and the security of preventing the process of entering unlocking information from being peeked is increased.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

FIG. 1 shows a circuit diagram of a portable electronic device according to an embodiment of the instant disclosure;

FIG. 2A shows a front view of a schematic diagram of the portable electronic device according to the embodiment of the instant disclosure;

FIG. 2B shows a back view of schematic diagram of the portable electronic device according to the embodiment of the instant disclosure;

FIG. 3 shows a circuit diagram of an alternative portable electronic device according to an embodiment of the instant disclosure;

FIG. 4 shows a circuit diagram of another alternative portable electronic device according to an embodiment of the instant disclosure;

FIG. 5 shows a schematic diagram of the alternative portable electronic device according to the embodiment of the instant disclosure;

FIG. 6 shows a flow chart of an automatic unlocking method of a portable electronic device according to an embodiment of the instant disclosure;

FIG. 7 shows a flow chart of an alternative automatic unlocking method of a portable electronic device according to an embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

[Embodiment of Portable Electronic Device]

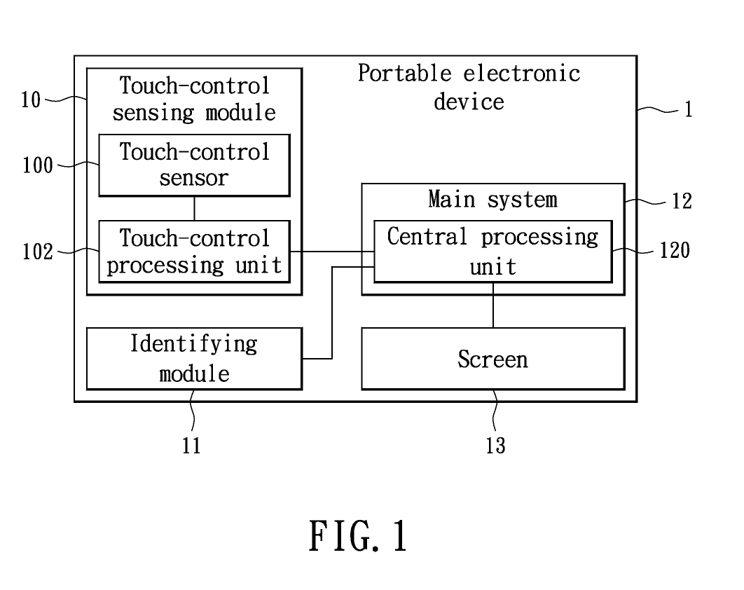

Referring to FIG. 1, a circuit diagram of a portable electronic device according to the present embodiment is illustrated. A portable electronic device 1 of the present embodiment includes a touch-control sensing module 10 and an identifying module 11. Besides, the portable electronic device 1 also includes a main system 12 and a screen 13. The touch-control sensing module 10, the identifying module 11, and the screen 13 are respectively coupled to the main system 12. Among which, the touch-control sensing module 10 further includes a plurality of touch-control sensors 100 and a touch-control processing unit 102.

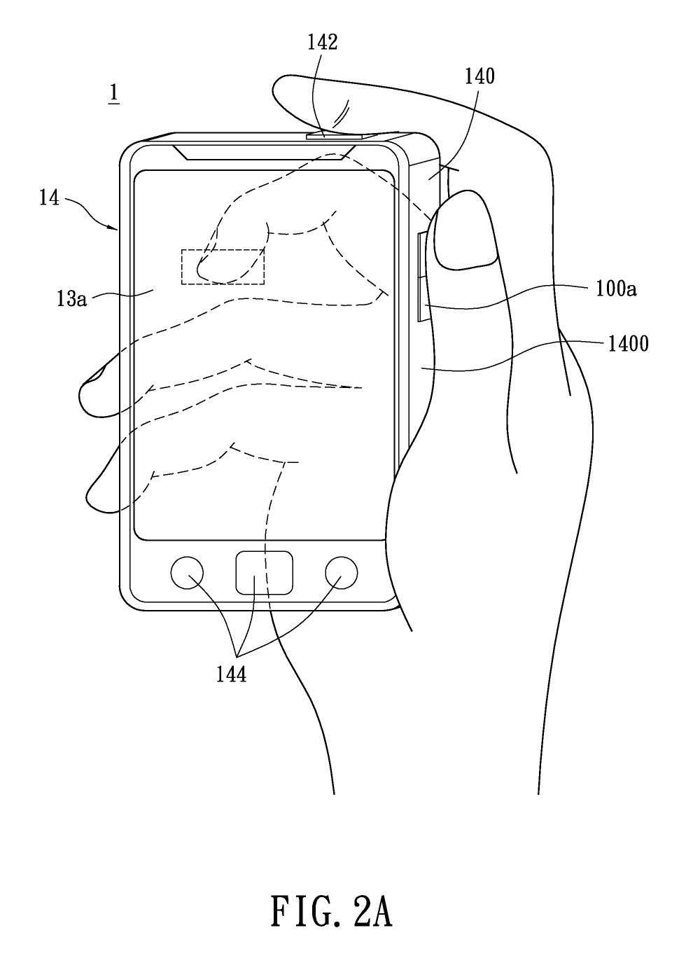

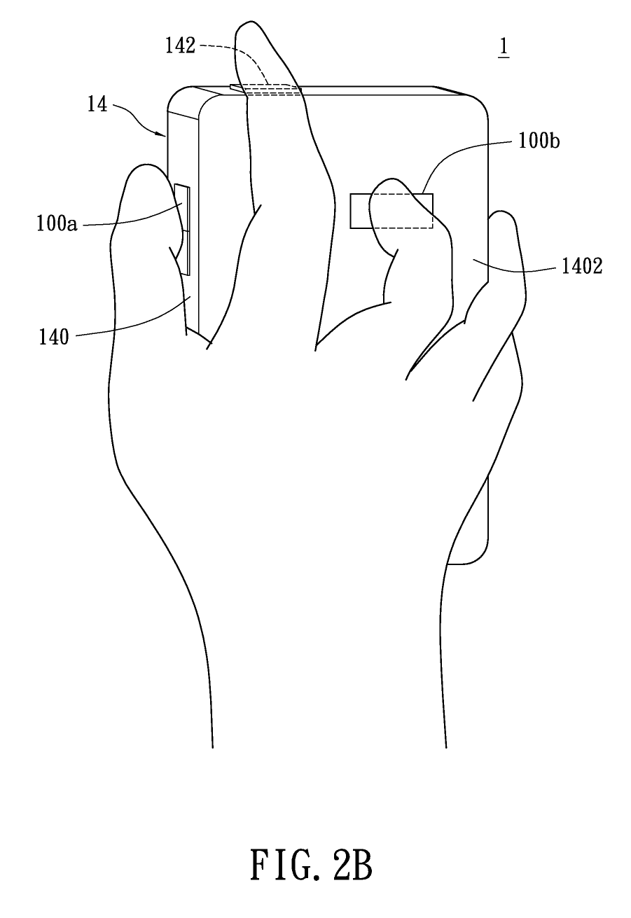

Referring to FIG. 2A, a front view of circuit diagram of the portable electronic device according to the present embodiment is illustrated. The portable electronic device 1 may be a mobile communication device such as a smart phone, a tablet PC, a multimedia player and others; the portable electronic device 1 shown in FIGS. 2A and 2B is an example of the mobile communication device. The portable electronic device 1 has a body 14, and the body 14 includes a casing 140. A power button 142, a function button 144, a touch-control screen 13a, and a touch-control sensor 100a are disposed on the casing 140, while the touch-control processing unit 102, the identifying module 11, and the main system 12 illustrated in FIG. 1 are placed in the body 14.

Back to FIG. 1, operating modes of the portable electronic device 1 include a suspend mode and a work mode. When the portable electronic device 1 is switched to the work mode, the screen 13 of the portable electronic device 1 is switched on, and the main system 12 executes operations or services demanded by a user according to an operation of the user. Taking the example of the mobile communication device of the present embodiment, the main system 12 includes: a Bluetooth module, a Wi-Fi module, a USB module, a telecommunications module, a MP4 module, an image retrieving module, or other modules for services such as providing an internet connection, a wired or wireless information transmission, a voice communication, a multimedia playing, or a photo shooting and recording.

After a certain time period of not using the portable electronic device 1, the portable electronic device 1 is switched to the suspend mode to save power. When the portable electronic device 1 is under the suspend mode, the power supply for all the modules in the main system 12 are suspended to be switched into a power-saving mode, and the screen 13 is also switched to an off mode to decrease the consuming of power, until the portable electronic device 1 is switched to the work mode again.

The touch-control sensing module 10 is for sensing a contact gesture of the user when the portable electronic device 1 is switched to the suspend mode. The touch-control sensors 100 of the touch-control sensing module 10 are respectively disposed on different positions of the casing 140 (shown in FIG. 2), and the positions are where easily contacted by fingers of the user when holding the portable electronic device 1. Referring to FIGS. 2A and 2B, FIG. 2A shows a front view of the schematic diagram of the portable electronic device 1 while FIG. 2B shows a back view of the schematic diagram of the portable electronic device 1. To give an example, the portable electronic device 1 includes at least 2 touch-control sensors, respectively disposed on a side 1400 and a reverse side 1402 relative to a touch-control screen 13a of the casing 140 of the portable electronic device 1. The former is a touch-control sensor 100a shown as FIG. 2A; the latter is a touch-control sensor 100b shown as FIG. 2B. As holding the portable electronic device 1, the user is able to effortlessly and simultaneously contact the touch-control sensors 100a and 100b disposed in different positions to generate sensing signals. To be more specific, the touch-control sensors 100, 100a, and 100b may be capacitive touch-control panels, resistive touch-control panels, or infrared sensors.

Disposed positions and numbers of the touch-control sensors 100 are not limited to the disposed positions and numbers shown in FIGS. 2A and 2B. In order to make easy contact for the user, it may be designed as the above setting; that is, the disposed positions are where the fingers of the user contact effortlessly, and the numbers of the touch-control sensors 100 allow the user to contact simultaneously with single hand. However, to avoid an easily accidental contact of the user, the disposed positions may be designed to be where the user not being able to easily contact simultaneously when holding the portable electronic device 1, or the number of the touch-control sensors 100 may be increased to avoid leading to an accidental unlocking operation.

Back to FIG. 1, the touch-control processing unit 102 of the present embodiment is coupled to each of the touch-control sensors 100 and the main system 12, for detecting the sensing signals outputted because of the contact, and according to received sensing signals to determine whether the contact gesture of the user matches a predetermined gesture. Based on the capacitive touch-control panel, the resistive touch-control panel, or the infrared sensor as described above, the touch-control processing unit 102 of the present embodiment may correspondingly be a capacitive touch-control processing panel, a resistive touch-control processing panel, or an infrared processing sensor. The touch-control processing unit 102 detects respective signals generated by each of the positions, the order, and the time of the contact to determine the contact gesture of the user, and compares the contact gesture with the predetermined gesture to determine if the contact gesture matches the predetermined gesture.

Taken examples of the touch-control sensors 100a and 100b, it is assumed that the predetermined gesture is that the touch-control sensors 100a and 100b are simultaneously and continuously contacted for over 3 seconds. Based on the sensing signals respectively outputted due to the contact of the touch-control sensors 100a and 100b of the user, the touch-control processing unit 102 determines whether the two signals are detected simultaneously and lasting for over 3 seconds. If the touch-control processing unit 102 simultaneously received the two sensing signals and both of the sensing signals last for over 3 seconds, the contact gesture of the user is determined to be matching the predetermined gesture. Yet, the predetermined gesture may be a various combination of order, durance of time, and positions of the contact gesture, and is not limited thereto.

In the present embodiment, when the touch-control processing unit 102 determines that the contact gesture matches the predetermined gesture according to the sensing signals, an enabled signal is outputted to the main system 12 to enable the identifying module 11.

The identifying module 11 is coupled to the main system 12 and starts retrieving an identification data wirelessly upon being enabled by the main system 12. The identifying module 11 may be a radio frequency (RF) reader module (e.g. RFID reader) for reading a radio frequency tag with the identification data. The radio frequency tag is placed outside of the portable electronic device 1; for example, the radio frequency tag may be stored inside of a shirt pocket of the user of the portable electronic device 1. The identifying module 11 may further record a set of a predetermined data for comparing if the read identification data matches the predetermined data. The identification data and the predetermined data may be codes of combinations of letters and/or numbers, or patterns formed by certain order of strokes.

When the identification data matches the predetermined data, the identifying module 11 determines that the identification data is confirmed. Based on a result of the identification data being confirmed, the main system 12 and the screen 13 of the portable electronic device 1 exit the power-saving mode and start preparing for operations or services, and the portable electronic device 1 is switched from the suspend mode to the work mode. If the RF tag reading module reads not any of the RF tag with the identification data, or the data read from the RF tag does not match the predetermined data, then the portable electronic device 1 is not switched to the work mode, and the screen 13 stays off to prevent people without the RF tag with the confirmed identification data from seeing or using the portable electronic device 1.

Furthermore, after the identifying module 11 retrieving the confirmed identification data, the screen 13 is switched on to receive the identification data retrieved by the identifying module 11. For example, if the screen 13 is a touch-control screen, and the identification data is a set of code or a pattern formed by certain order of strokes, the identifying module 11 switches the touch-control screen on and send the retrieved code or pattern to the touch-control screen to unlock the screen, and allows the user to make operations on the portable electronic device 1 with the touch-control screen.

In the present embodiment, the main system 12 may further include a central processing unit 120 for receiving the enabled signal outputted by the touch-control processing unit 102, and controlling a power supply from a power supply unit to the identifying module 11 according to the enabled signal thus to enable the identifying module 11, and retrieving notifications of the identification data being confirmed, and controlling operations of the screen 13 and other modules after the portable electronic device 1 is switched to the work mode.

For power saving, if the portable electronic device 1 is switched from the suspend mode to the work mode, then a touch-control sensing module 10 is switched to the power-saving mode. For example, the central processing unit 12 of the main system 12 controls the power supply unit by suspending power supply to the touch-control sensing module 12. If the portable electronic device 1 is idle for the certain time period and is switched to the suspend mode, the touch-control sensing module 10 regains the power supply and restarts to sense the contact gesture of the user under the suspend mode. On the other hand, when the portable electronic device 1 is switched to the suspend mode, the identifying module 11 is in no need of being enabled before the touch-control sensing module 10 senses the contact gesture that matches the predetermined gesture. Therefore, when the portable electronic device 1 is switched from the work mode to the suspend mode, the identifying module 11 may also be switched to the power-saving mode to save power, until the main system 12 receives the enabled signal and enables the identifying module 11.

The above-described power supply unit of the touch-control sensing module 10 and the identifying module 11 may be the power supply unit shared by the modules of the portable electronic device 1, or separate the power supply units disposed to the touch-control sensing module 10 and the identifying module 11 respectively.

[Embodiment of Another Portable Electronic Device]

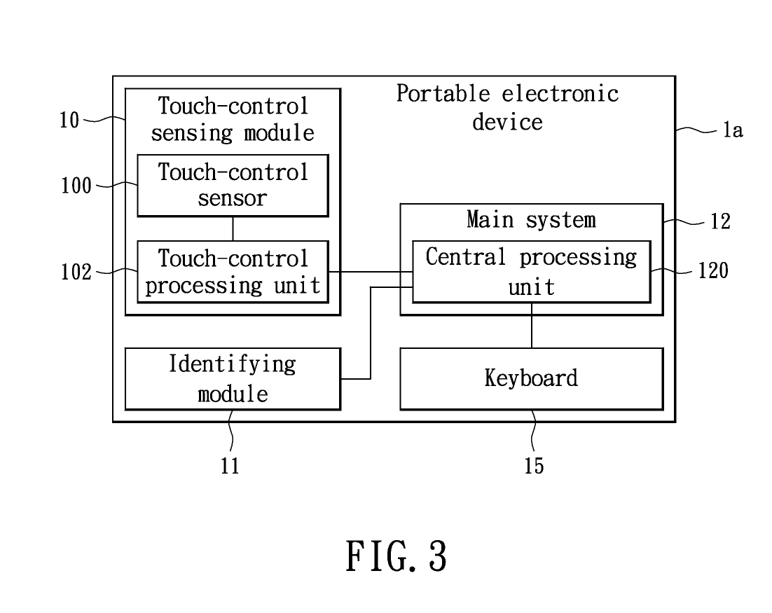

Referring to FIG. 3, a circuit diagram of an alternative portable electronic device according to the present embodiment is illustrated. For quick understanding of the present embodiment, the circuit diagram illustrated in FIG. 1 is also referred. Compared with the circuit diagram illustrated in FIG. 1, a portable electronic device 1a illustrated in FIG. 3 further includes a keyboard 15 other than a touch-control sensing module 10, an identifying module 11, and a main system 12.

In the present embodiment, the identifying module 11 is coupled between the touch-control sensing module 10 and the main system 12. After a touch-control processing 102 determining that a contact gesture matches a predetermined gesture according to sensing signals of a plurality of touch-control sensors 100, the touch-control processing unit 102 outputs an enabled signal to the identifying module 11. The identifying module 11 is enabled thanks to the enabled signal and starts retrieving an identification data wirelessly.

When the identifying module 11 retrieves a confirmed identification data such as a code matching a predetermined data, the identifying module 11 notifies the main system 12 to switch on modules and a screen (not shown in FIG. 3) of the system 12, and thereby, the portable electronic device 1a is switched from a suspend mode to a work mode. In the present embodiment, the identifying module 11 may further switch on the keyboard 15 of the portable electronic device 1a, and send a confirmed code to the keyboard for entering, and then the code entered by the keyboard 15 starts the main system 12. The keyboard 15 may be an entity keyboard or a software-designed virtual keyboard set on a body (not shown in FIG. 3) of the portable electronic device 1a.

In order to have the identifying module 11 directly receive the enabled signal from the touch-control sensing module 10 and retrieve the identification data, the identifying module 11 of the present embodiment may also be disposed with separate power management units to be automatically power-supplied and to operate after receiving the enabled signal, and is switched to a power-saving mode when the portable electronic device 1a is switched from the work mode to the suspend mode.

As for detailed descriptions of specific elements of the touch-control sensing module 10, the identifying module 11, the main system 12, and exemplary ways of comparing gestures or identifying an identification data, it is not repeatedly described in the present embodiment, and please refers to the former embodiment.

[Embodiment of Another Alternative Portable Electronic Device]

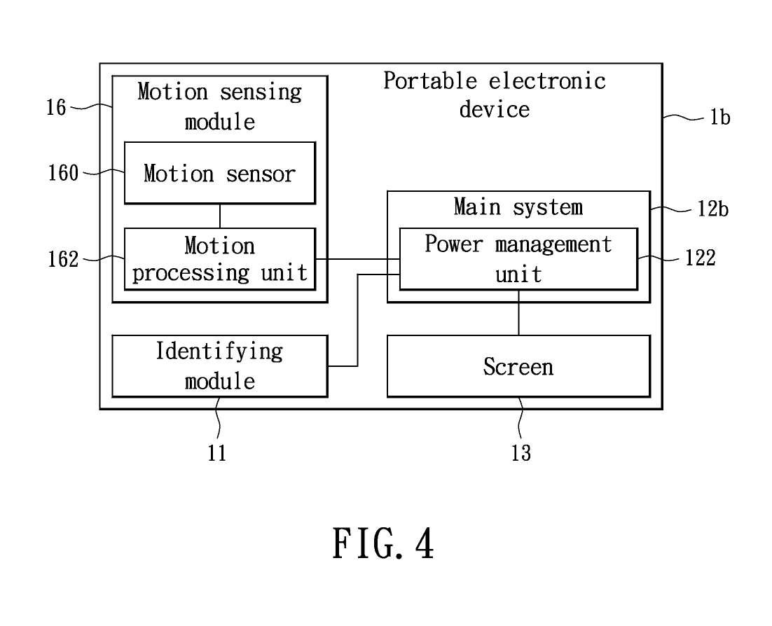

Referring to FIG. 4, a circuit diagram of another alternative portable electronic device to be capable of automatic unlocking provided by the instant disclosure according to the present embodiment is illustrated. Compared with the circuit diagram of a portable electronic device 1 illustrated in FIG. 1, a portable electronic device 1b also includes an identifying module 11, a main system 12b, and a screen 13, but the touch-control sensing module 10 in FIG. 1 is replaced with a motion sensing module 16. Other than that, the central processing unit 120 is replaced with a power management unit 122 in the main system 12b. The motion sensing module 16 includes at least a motion sensor 160 and a motion processing unit 162.

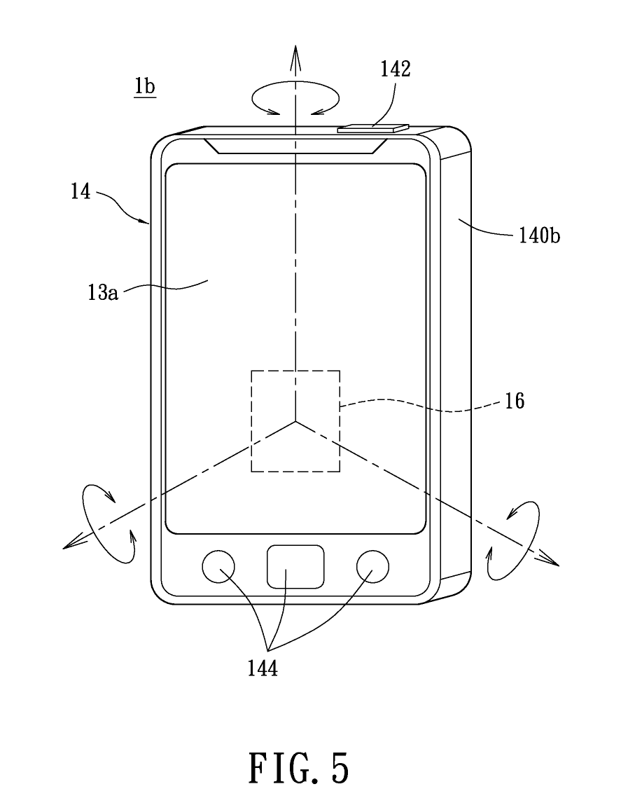

Referring to a schematic diagram of the portable electronic device 1b according to the embodiment illustrated in FIG. 5. The motion sensing module 16 is placed in the body 10 of the portable electronic device 1b for sensing a motion status of the portable electronic device 1b.

When the portable electronic device 1b is switched to a suspend mode for being idle for a certain period time period, the motion sensing module 16 is enabled to sense the motion status of the portable electronic device 1b. In which, the motion sensor 160 generates a sensing signal according to a motion of moving or slanting made by a user when holding the portable electronic device 1b. The motion sensor 160 may be an accelerometer, a gyroscope, or a combination of the accelerometer and the gyroscope. The motion process unit 162 receives the sensing signal generated by the motion sensor 160 such as a movement and a speed of the portable electronic device 1b sensed by the accelerometer, or/and an angular velocity of the portable electronic device 1b sensed by the gyroscope. The motion processing unit 162 calculates the motion status of the portable electronic device 1b to determine whether the motion status matches a predetermined status or not.

When the motion processing unit 162 determines that the motion status of the portable electronic device 1b matches the predetermined status, an enabled signal is outputted to the main system 12b to enable the identifying module 11 from a power-saving mode, and thus the identifying module 11 starts retrieving an identification data wirelessly. In the present embodiment, the enabled signal may be outputted to the power management unit 122 of the main system 12b. The power management unit 122 manages power sources of modules and the screen 13 of the portable electronic device 1b; for example, under the suspend mode, the power management unit 122 suspend power supply for most of the modules and the screen 13 to switch most of the modules to the power-saving mode and shut the screen 13. After the power management unit 122 receives the enabled signal, the power is supplied to the identifying module 11 to enable the identifying module 11.

The identifying module 11 retrieves the identification data out of the portable electronic device 1b wirelessly, like a RF tag reading module retrieving the identification data of a RF tag. After the identifying module 11 determines that the identification data is confirmed, the power management unit 122 of the main system 12b is notified to arouse the modules and the screen 13 under the power-saving mode. Thereby, the portable electronic device 1b is switched from the suspend mode to a work mode. If the screen 13 is a touch-control screen, the identifying module 11 further switches on the screen 13 and has the screen 13 receive the identification data such as a code or a certain pattern to unlock the screen, and allows the user to make operations with the touch-control screen.

When the portable electronic device 1b is switched from the suspend mode to the work mode, there is temporarily no need of sensing the motion status of the portable electronic device 1b to determine whether to switch to the work mode or not, and thus the motion sensing module 16 is switched to the power-saving mode to save power under a control of the power management unit 122.

Identical or similar details in the present embodiment compared to the details in FIG. 1 are not repeatedly described thereto, and please refer to corresponding descriptions of the embodiment shown in FIG. 1.

It is worth mentioning that in other embodiments, the identifying module 11 may be coupled between the motion sensing module 16 and the main system 12b as the configuration shown in FIG. 3. After the motion process unit 162 determines that the motion status matches the predetermined status, the enabled signal is directly outputted to the identifying module 11 to have the identifying module 11 be enabled and start retrieving the identification data. For other related detailed descriptions of the identifying module 11, please refer to the descriptions of the embodiment corresponding to FIG. 3.

[Embodiment of Automatic Unlocking Method of Portable Electronic Device]

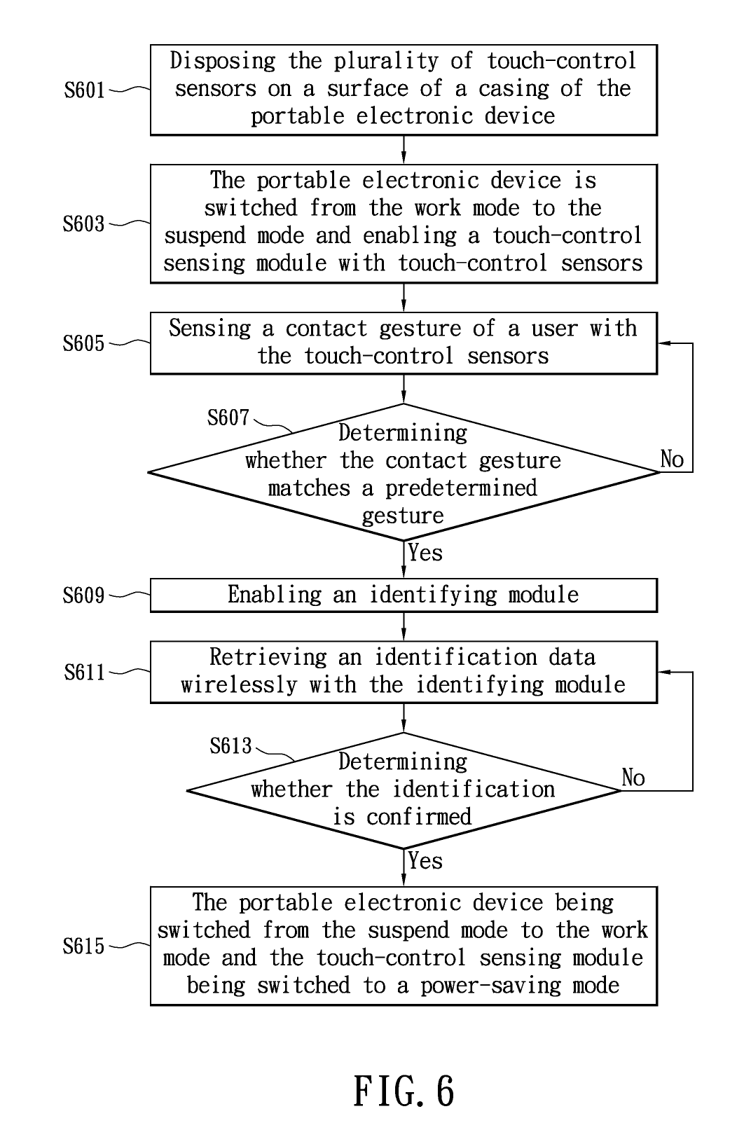

Referring to FIG. 6, a flow chart of an automatic unlocking method of a portable electronic device according to an embodiment is illustrated. The method of the present embodiment is executable for a portable electronic device with a touch-control sensing module and an identifying module as shown in FIG. 1 or FIG. 3, and thus please refers to FIG. 1 or FIG. 3 for better understanding.

In the present embodiment, a plurality of touch-control sensors of a touch-control sensing modules are disposed on a surface of a casing of the portable electronic device (S601). After the portable electronic device being started and switched from a work mode to a suspend mode and being idle for a certain time period, the touch-control sensing module is enabled (S603), and senses a contact gesture of a user with the touch-control sensors disposed on the surface of the casing (S605). After the touch-control sensors sensing the contact gesture of the user, the touch-control sensing module compares the contact gesture with a predetermined gesture to determine whether the contact gesture of the user matches the predetermined gesture (S607). If the contact gesture does not match the predetermined gesture, the touch-control sensing module stays enabled so as to be still able to sense the contact gesture of the user with the touch-control sensors (605). If the touch-control sensing module determines that the contact gesture matches the predetermined gesture, the identifying module is further enabled (S609).

The identifying module starts retrieving an identification data out of the portable electronic device wirelessly after being enabled (S611), and determines whether the retrieved identification data to be a confirmed identification data (S613). Taking an example of retrieving reading the identification data of a RF tag, and comparing a retrieved identification data with a predetermined identification data, the retrieved identification data out of the portable electronic device is then determined to be matching the predetermined identification data or not. If the identifying module determines that the retrieved identification data is not matching, the identifying module stays enabled to keep retrieving the identification data (S611). If the identifying module determines that the retrieved identification data is confirmed to be matching, the portable electronic device is switched from the suspend mode to the work mode, and the touch-control sensing module is also to be switched to the power-saving mode (S615). Thereby, the main system and the screen of the portable electronic device exit the power-saving mode and start preparing for offering service. In addition, when the portable electronic device is switched to the work mode, the touch-control sensing module is switched to the power-saving mode to save power for there is temporarily no need of sensing the contact gesture of the user.

Before the portable electronic device is switched to the suspend mode, the touch-control sensing module under the power-saving mode previously is enabled (back to S603), and the identifying module is switched to the power-saving mode to save power until a sensed contact gesture is determined to be matching the predetermined gesture by the touch-control sensing module, and the identifying module is enabled again.

When the identification data is determined to be the confirmed identification data (S613: an answer of yes to a determining result), the identifying module may switch on the screen or a keyboard first to send the identification data to the screen or the keyboard to unlock the screen, and thereby, once the portable electronic device is switched to the work mode, the user may see the screen or make operation with the screen immediately.

In a process of enabling the identifying module according to the enabled signal outputted by the touch-control sensing module, the identifying module may be enabled by the main system since the enabled signal is first received by the main system (as shown in FIG. 1), or the identifying module may be enabled directly by the sent enabled signal outputted from the touch-control sensing module (as shown in FIG. 3).

Regarding switches between the work mode and the suspend mode of the portable electronic device, sensing and a comparison of the contact gesture with the touch-control sensing module, retrieving and determination of the identification data with the identifying module, details of the process are respectively described in the embodiments corresponding to FIGS. 1 and 3, and thus not repeatedly described thereto.

[Embodiment of an Alternative Automatic Unlocking Method of Portable Electronic Device]

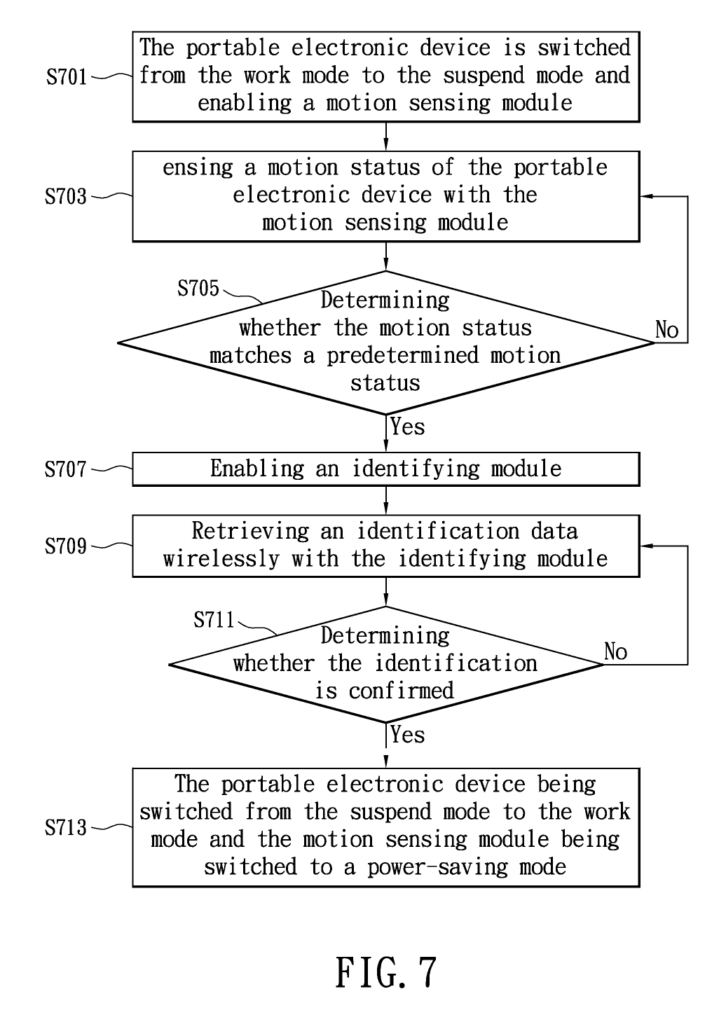

Referring to FIG. 7, a flow chart of an alternative automatic unlocking method of a portable electronic device according to an embodiment is illustrated. The method of the present embodiment is executable for a portable electronic device with a motion sensing module and an identifying module as shown in FIG. 4, and thus please refers to FIG. 4 for better understanding. The portable electronic device includes operating modes of a work mode and a suspend mode.

When the portable electronic device is switched from the work mode to the suspend mode, the motion sensing module is enabled (S701), and senses a motion status of the portable electronic device with a motion sensor of the motion sensing module (S703), and the motion status is such as a movement or a slating angle of the portable electronic device. After sensing the motion status, the motion sensing module compares the motion status with a predetermined status to determine whether the motion status matches the predetermined status or not (S705). If the motion status does not match the predetermined status, the motion sensing module stays enabled and keeps sensing the motion status of the portable electronic device (back to S703).

If the motion status is determined to be matching the predetermined status by the motion sensing module, the motion sensing module is then enabled (S707) and starts retrieving an identification data wirelessly (S709). For instance, the identifying module is enabled by an enabled signal outputted by the motion sensing module and starts reading a RF tag out of the portable electronic device to retrieve the identification data of the RF tag.

After retrieving the identification data, the identifying module then further determines whether the retrieved identification data is confirmed (S711), and that is such as determining whether the retrieved identification data matches the a predetermined data. If the retrieved identification data is not confirmed, the identifying module stays enabled and keeps retrieving another identification data (back to S709). If the retrieved identification data is confirmed, the portable electronic device is switched from the suspend mode to the work mode, and the motion sensing module is switched to the power-saving mode (S713), to have the main system and the screen or the keyboard exit the power-saving mode and start preparing for offering service.

When being switched to the work mode after S713, the portable electronic device may be switched back to the suspend mode once being idle for a certain time period (back to S701), and the identifying module is then further switched to the power-saving mode and waited for being enabled again when there is another motion status matches the predetermined status.

Regarding switches between the work mode and the suspend mode of the portable electronic device, sensing and a comparison of the contact gesture with the touch-control sensing module, retrieving and determination of the identification data with the identifying module, details of the process are respectively described in the embodiments corresponding to FIGS. 1-5, and thus not repeatedly described thereto.

To sum up, according the embodiments of the instant disclosure, the portable electronic device and the automatic unlocking method thereof satisfy both convenience and security when the user uses the portable electronic device.

Among which, a two-staged unlocking procedure is adopted in the devices and the methods thereof of the above described embodiments, when the portable electronic device is under the suspend mode, there is first just the identifying module of the electronic device to be aroused to start operating based on the contact gesture of the user or the motion status of the device. Then after the identifying module wirelessly retrieving the confirmed identification data which corresponds to the portable electronic device, the main system of the portable electronic device is aroused due to the confirmed identification data, and the portable electronic device is switched to the work mode from the suspend mode. Thereby, only the user with the confirmed identification data is able to arouse the portable electronic device under the suspend mode, and other users without the confirmed identification data are prevented from using the portable electronic device at random or obtaining messages in the portable electronic device.

In addition, in the devices and the methods thereof in the embodiments of the instant disclosure, the identification data is automatically and wirelessly retrieved by the identifying module, and thus there is no need for the user to enter a code or an unlocking pattern to unlock the screen; therefore, the unlocking information is protected from being peeked by others, and on the other hand, for the user with the confirmed identification data, comparing to the methods of entering the code or drawing certain pattern on the screen to unlock, it is much more simple and convenient to provide a contact gesture matching the predetermined gesture, or to provide a motion status matching the predetermined status to switch the portable electronic device back to the mode that is ready to operate or offer service.

Furthermore, as mentioned in the embodiments of the instant disclosure, the touch-control sensing module for sensing the contact gesture or the motion status, and the identifying module for retrieving the identification data may be respectively switched to the power-saving mode to avoid a waste of the power of the portable electronic device under situations of no present missions.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A portable electronic device having a suspend mode and a work mode, comprising:
a body, including a casing;
a touch-control sensing module, having a plurality of touch-control sensors, and the plurality of touch-control sensors are disposed on the casing for sensing a contact gesture of a user; and
an identifying module, placed in the body for retrieving an identification data;
wherein when the portable electronic device is switched to the suspend mode, the touch-control sensing module is enabled to sense the contact gesture of the user, and when the contact gesture sensed by the touch-control sensing module matches a predetermined gesture, the identifying module is enabled to retrieve the identification data wirelessly, wherein after the identification data is confirmed by the identifying module, the suspend module is switched to the work mode.

2. The portable electronic device according to claim 1, wherein the portable electronic device has a main system, and the touch-control sensing module further comprises:
a touch-control processing unit, coupled to the plurality of touch-control sensors and the main system, determining whether the contact gesture of the user matches the predetermined gesture according to sensing signals outputted by the plurality of touch-control sensors, and outputting an enabled signal to the main system when the contact gesture of the user is determined to match the predetermined gesture.

3. The portable electronic device according to claim 1, wherein the touch-control sensing module determines whether the contact gesture matches the predetermined gesture according to a position, an order and a time of the user's contact to the plurality of touch-control sensing sensors.

4. The portable electronic device according to claim 3, wherein the plurality of touch-control sensors are respectively disposed on one side of the casing and a reverse side of the casing relative to a screen.

5. The portable electronic device according to claim 1, wherein the plurality of touch-control sensors are capacitive touch-control panels, resistive touch-control panels, or infrared sensors.

6. The portable electronic device according to claim 1, wherein when the portable electronic device is switched to the work mode, the touch-control sensing module is switched to a power-saving mode.

7. The portable electronic device according to claim 1, wherein the identifying module is a radio frequency tag reading module for reading a radio frequency tag outside of the portable electronic device, wherein the radio frequency tag records an identification data.

8. The portable electronic device according to claim 1, wherein the portable electronic device has a main system, and the identifying module is coupled to the main system and the touch-control sensing module, and when the contact gesture sensed by the touch-control sensing module matches the predetermined gesture, the identifying module is enabled to retrieve the identification data.

9. The portable electronic device according to claim 1, wherein when the portable electronic device is switched to the suspend mode, the identifying module is switched to a power-saving mode.

10. The portable electronic device according to claim 1, wherein when the identifying module is enabled, the identifying module switches on a touch-control screen of the portable electronic device to receive the identification data.

11. The portable electronic device according to claim 1, wherein when the identifying module is enabled, the identifying module switches on a keyboard of the portable electronic device to receive the identification data.

12. A portable electronic device having a suspend mode and a work mode, comprising:
a body, including a casing;
a motion sensing module for sensing a motion status of the portable electronic device; and
an identifying module, placed in the body for retrieving an identification data;
wherein when the portable electronic device is under the suspend mode, the motion sensing module is enabled to sense the motion status of the portable electronic device, and when the motion status of the portable electronic device sensed by the motion sensing module matches a predetermined status, the identifying module is enabled to retrieve the identification data wirelessly, wherein after the identification data is confirmed by the identifying module, the portable electronic device is switched from the suspend mode to the work mode.

13. The portable electronic device according to claim 12, wherein the portable electronic device has a main system, and the motion sensing module further comprises:
a motion processing unit, coupled to the main system, for determining whether the motion status of the portable electronic device matches the predetermined status, and outputting an enabled signal to the main system when the motion status of the portable electronic device matches the predetermined status.

14. The portable electronic device according to claim 12, wherein when the portable electronic device is switched to the work mode, the motion sensing module is switched to a power-saving mode.

15. The portable electronic device according to claim 12, wherein the identifying module is a radio frequency tag reading module for reading a radio frequency tag outside of the portable electronic device, wherein the radio frequency tag records the identification data.

16. The portable electronic device according to claim 12, wherein when the portable electronic device is switched to the suspend mode, the identifying module is switched to a power-saving mode.

17. An automatic unlocking method of a portable electronic device, the portable electronic device comprising a touch-control sensing module and an identifying module, in which the touch-control sensing module comprises a plurality of touch-control sensors, and the portable electronic device having a suspend mode and a work mode, the method comprising:
disposing the plurality of touch-control sensors on a casing of the portable electronic device;
sensing a contact gesture of a user via the plurality of touch-control sensors when the portable electronic device is switched to the suspend mode;
determining whether the contact gesture matches a predetermined gesture;
enabling the identifying module to retrieve an identification data wirelessly when the contact gesture matches the predetermined gesture; and
switching from the suspend mode to the work mode to switch on a screen of the portable electronic device when the identification data is confirmed by the identifying module.

18. The automatic unlocking method according to claim 17, wherein when the portable electronic device is switched to the work mode, the touch-control sensing module is switched to a power-saving mode.

19. The automatic unlocking method according to claim 18, wherein when the portable electronic device is switched to the suspend mode, the identifying module is switched to the power-saving mode.

20. An automatic unlocking method of a portable electronic device, the portable electronic device comprising a motion sensing module and an identifying module, and having a suspend mode and a work mode, the method comprising:
sensing a motion status of the portable electronic device via the motion sensing module when the portable electronic device is switched to the suspend mode;
determining whether the motion status matches a predetermined status;
enabling the identifying module to retrieve an identification data when the motion status matches the predetermined status; and
switching from the suspend mode to the work mode to switch on a screen of the portable electronic device when the identification data is confirmed by the identifying module.
